(19) United States
(12) Patent Application Publication
(10) Pub. No.: US 2009/0263623 A1
(43) Pub. Date: Oct. 22, 2009

(54) SCRIBBLING SUBSTRATE

(75) Inventor: Hsia-Yuen Chen, Taichung (TW)

Correspondence Address: EGBERT LAW OFFICES, 412 MAIN STREET, 7TH FLOOR, HOUSTON, TX, 77002, US

(73) Assignee: BEIJING ZBSD PATENT & TRADEMARK AGENT LTD., Beijing (CN)

(21) Appl. No.: 12/301,027

(22) PCT Filed: May 17, 2006
(86) PCT No.: PCT/CN06/01005

§ 371 Date: Nov. 15, 2008

(51) Int. Cl. B32B 15/082; B32B 3/06; B32B 3/10

(52) U.S. Cl. 428/121; 428/137; 428/195.1; 428/458

(57) ABSTRACT

The present invention relates to a substrate for scribbling. The substrate is a scribbling board. The substrate is made of a rigid and ductile metal material and is provided at least with a first and a second surface. The first surface is attached to a scribbling layer. The present invention has simple construction to replace the prior art complex scribbling substrate, thereby greatly saving manufacturing costs with better industrial benefits.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a substrate for scribbling, and more particularly to an innovative substrate which is a scribbling board.

2. Description of Related Art Including Information Disclosed Under 37 CFR 1.97 and 37 CFR 1.98.

Conventional scribbling substrates (e.g. whiteboards) are commonly used due to the characteristics of ease-of-writing and ease-of-wiping off without powder. FIGS. 1 and 2 depict the structure of a conventional scribbling substrate, wherein the scribbling substrate comprises several fixed framing strips, covers, a thin-profile substrate, an intermediate sheet and a back board. These two thin-profile substrates are reversely arranged onto the front and rear surfaces of the intermediate sheet, and fastened onto the thin-profile substrates and intermediate sheet via several fixed framing strips. Next, a scribbling layer is electroplated onto the thin-profile substrate, and then the corners and sides of the substrates are enveloped by several covers to form a scribbling substrate.

However, the following shortcomings are observed during actual applications:

1. A conventional scribbling substrate has complex structure and a variety of components, leading to a time-consuming manufacturing process.

2. A conventional scribbling substrate can be fastened since two thin-profile substrates are attached onto front and rear surfaces of an intermediate sheet. But, the conventional substrate lacks functionality and space-saving as thin-profile substrates are interdependent.

3. To drill a hole and hang a box on the conventional scribbling substrate of superimposed layers, the through-hole may lead to loss of stability and rigidity of the substrate, and its interiors are likely exposed to damp air without aesthetics and more vulnerable to damage. Moreover, a plastic profile change cannot occur due to the confinement of its multilayer structure and material plasticity, along with possible local rupture when a marking letter is to be punched.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

Based on the innovative present invention, the substrate 10 is made of rigid and ductile metal material and provided at least with a first surface 101 and a second surface 102. The first surface 101 is attached with a scribbling layer 11. It is possible to resolve the problems of the prior art, such as complex structure, components and time-consuming manufacturing process. Thus, the present invention could replace conventional models and greatly save manufacturing costs with improved industrial benefits.

Based on technical characteristics ofthe substrate 10, such as rigidity and ductility, the present invention could be selectively embedded into the wall surface (c) to realize functional and decorative aesthetic effects. The substrate 10 of better plasticity allows for profile shaping, making it possible to improve from the problems of the prior art, such as lack of spatial functions since two thin-profile substrates of the scribbling substrate are not independent. Thus, the present invention could utilize the available space efficiently with better applicability.

Based on the innovative present invention, the substrate 10 allows the marking letter (15), brand and decorative pattern 19 to be punched into predefined locations, and the substrate 10 can be perforated with a through-hole 16 to hang the intended articles for multifunctional applications. It is possible to resolve the problems of the prior art, such as the through-hole leading to loss of stability and rigidity of the substrate and likely exposing its interiors to damp air without aesthetics and more vulnerable to damage. Plastic profile change cannot occur due to the confinement of its multilayer structure and material plasticity, along with possible local rupture when a marking letter is to be punched.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an exploded perspective view of typical scribbling substrate.

FIG. 2 shows a sectional view of typical scribbling substrate along a-a line of FIG. 1.

FIG. 3 shows a perspective view of scribbling substrate of the present invention.

FIG. 4 shows a sectional view of scribbling substrate of the present invention.

FIG. 5 shows a schematic view of the first preferred embodiment of scribbling substrate of the present invention.

FIG. 6 shows a front elevation view of the second preferred embodiment of scribbling substrate of the present invention.

FIG. 7 shows a sectional view of typical scribbling substrate along b-b line of FIG. 6.

FIG. 8 shows a perspective view of the third preferred embodiment of scribbling substrate of the present invention.

FIG. 9 shows a perspective view of the fourth preferred embodiment of scribbling substrate of the present invention.

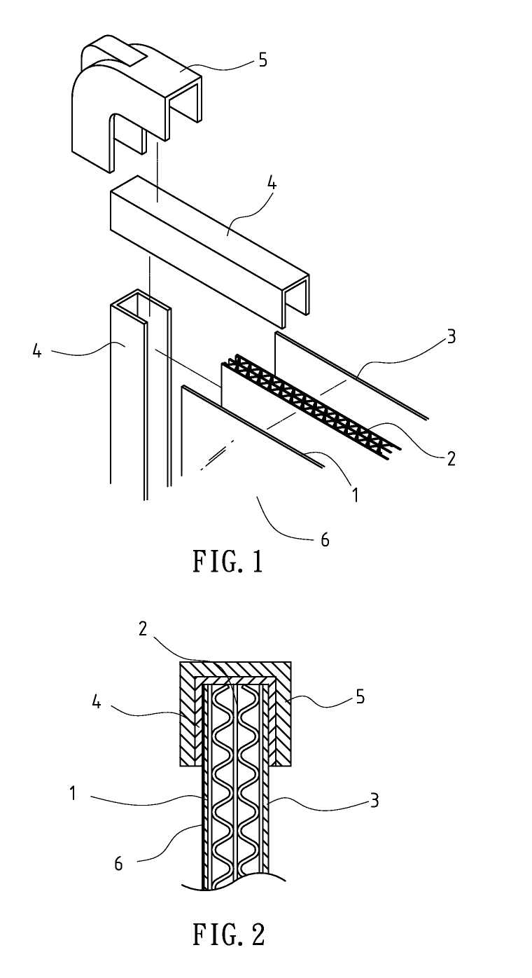

### DETAILED DESCRIPTION OF THE INVENTION

The features and the advantages ofthe present invention will be more readilyunderstood upon a thoughtful deliberation of the following detailed description of a preferred embodiment of the present invention with reference to the accompanying drawings.

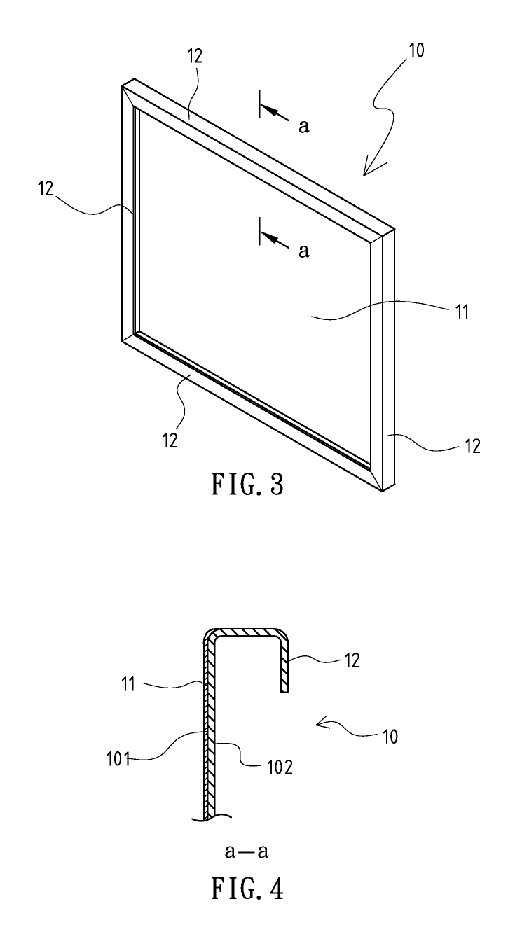

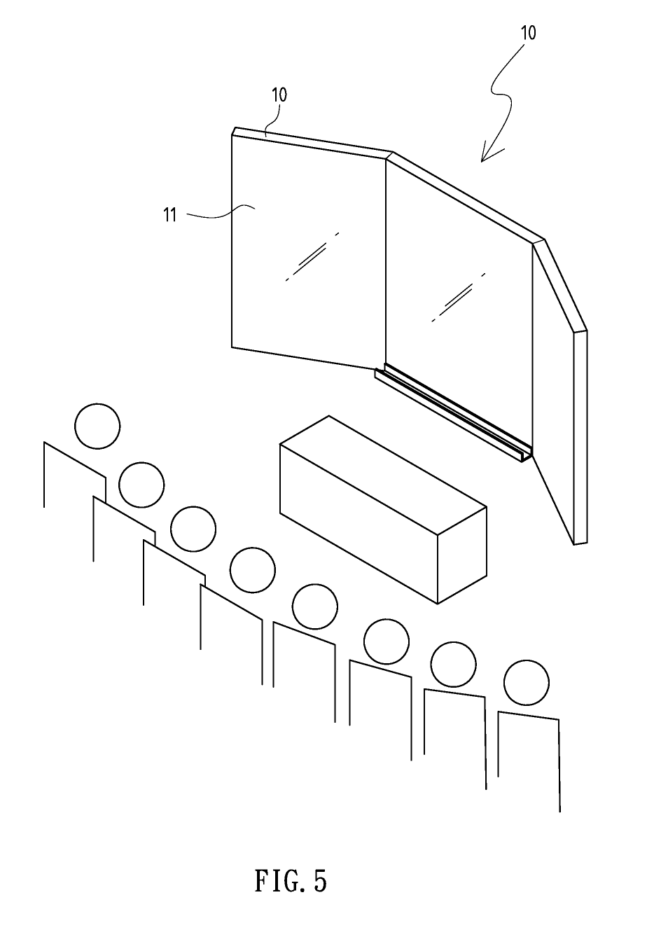

FIGS. 3 and 4 depict preferred embodiments of scribbling substrate of the present invention. The embodiments are provided only for explanatory purposes with respect to the patent claims.

Referring to FIGS. 3 and 4, the substrate 10 for scribbling is made of rigid and ductile material (metal as a preferred option). The substrate 10 is provided at least with a first surface 101 and a second surface 102. The first surface 101 is attached to a scribbling layer 11 by means of baking finish. The paint for the baking finish is mixed by silver paste, an acrylic resin. The first surface 101 forms a smooth surface so that the scribbling layer 11 allows wiping off letters written by a water-based marker.

At the periphery of the substrate 10, a reinforced framing strip 12 is extended and folded by the first surface 101, thereby improving the overall robustness of the substrate 10.

FIG. 5 depicts the second preferred embodiment of the present invention, wherein the substrate 10 can be used as scribbling board in the classrooms, meeting halls or public occasions, or projecting surface of projectors. With the ductility and plasticity of the substrate 10, both sides of the substrate 10 can be folded into three surfaces facing inwards, thus avoiding the possible visual obstruction against the audience due to the visual drop at both sides.

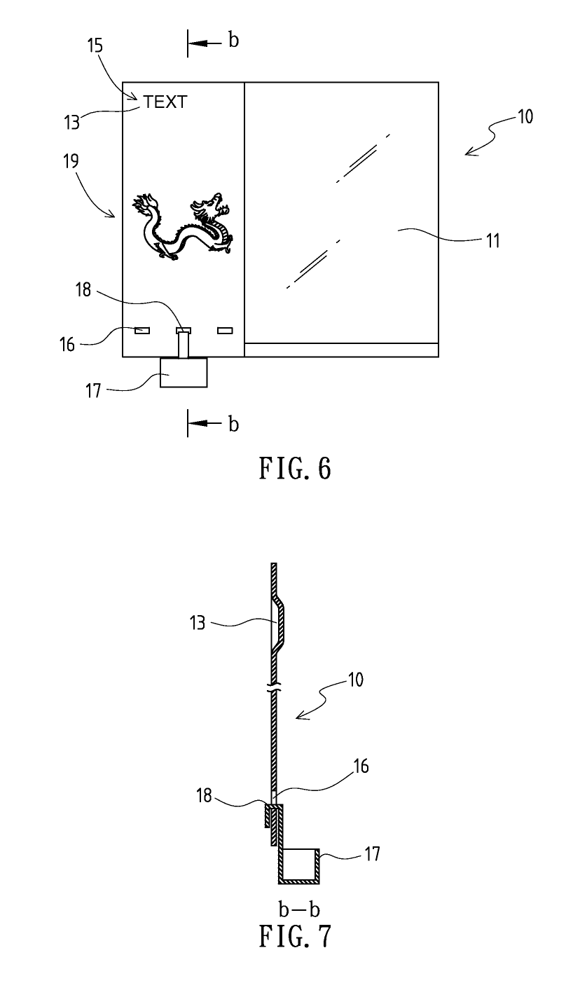

Referring to FIGS. 6 and 7, the substrate 10 can be used functionally in more applications. The substrate 10 can be selectively set into predefined blocks of scribbling layer 11, marking letter 15 or decorative pattern 19. An extruded portion 13 is punched into the desired marking letter 15, brand or pattern 19 to realize functional application and aesthetic effect. Additionally, a through-hole 16 is drilled at another preset position of the substrate 10 for hanging intended articles, e.g. a box 17 is hung on the through-hole 19 via a hook 18, thus meeting the diversified customer demands on arrangement of articles.

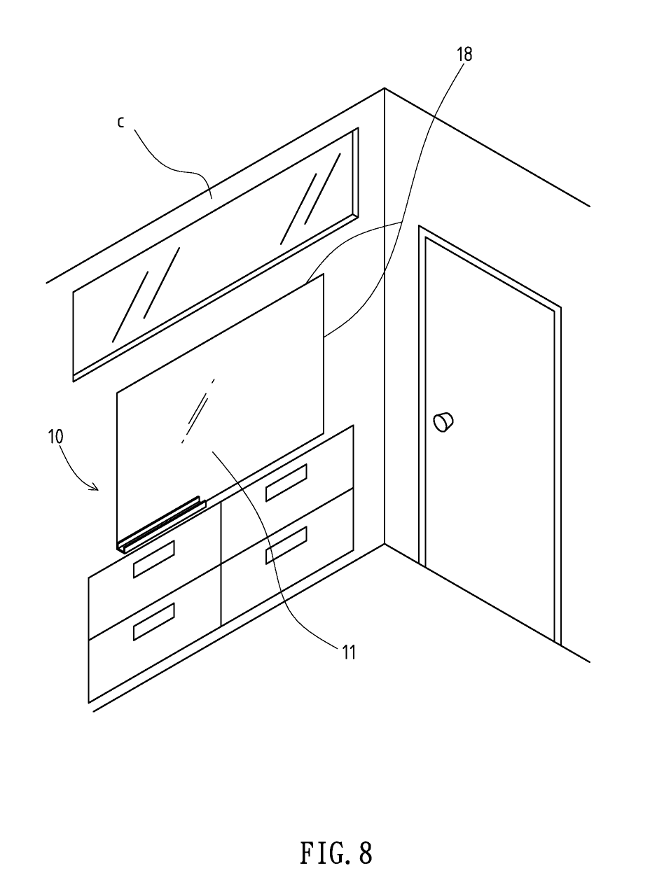

Referring to FIG. 8, the substrate 10 of ductility can be embedded into wall surface (c), since the substrate 10 can be attached flexibly without physical shedding in tune with the expansion on heating and contraction on cooling. A wall surface (c) is embedded into the periphery ofthe substrate 10 to form an embedded portion 18, so as to improve the spatial aspects of indoor design. The scribbling layer 11 could meet the children's desire for scribbling on the wall surface (c), or allow manually writing letters on the scribbling layer 11 for publicizing some messages. Moreover, the embedded substrate 10 is integrated with the wall surface (c) for space-saving purpose.

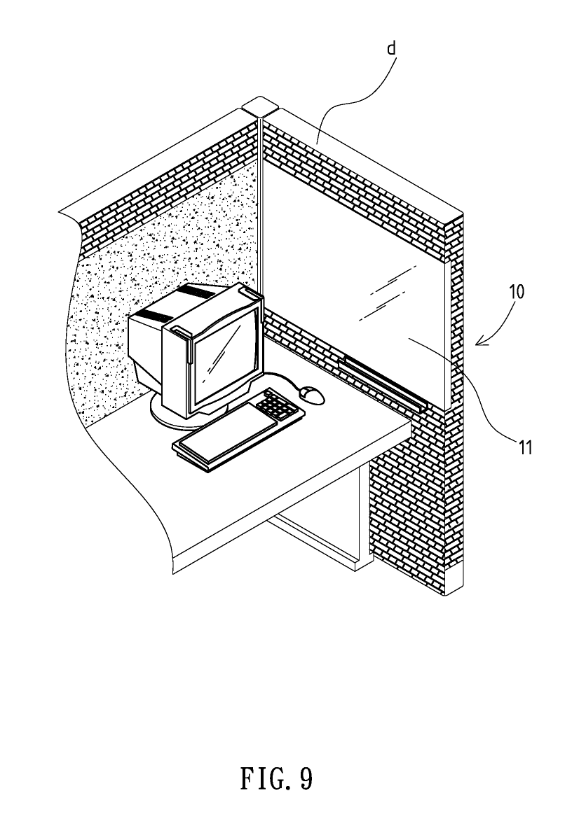

Referring to FIG. 9, the substrate 10 of proper rigidity and ductility can be assembled into the combined partition wall (d) of the offices, without the need of occupying space. The substrate 10 is also attached with a scribbling layer 11 for recording purpose by the office personnel, and the substrate 10 made of metal material can be used for positioning of magnets or preset paper sheets or cards.

Additionally, the scribbling layer 11 can be selectively set into predefined blocks for scribbling purpose.

There is enhanced efficacy of the present invention.

1. A substrate for scribbling, said substrate being comprised of rigid and ductile material, said substrate comprising: ______ a first surface; and
a second surface, said first surface being attached to a scribbling layer.

2. The substrate defined in claim 1, wherein said scribbling layer attached by baking finish, electroplating, oil film transfer and integrated film covering.

3. The substrate defined in claim 2, wherein said baking finish is comprised of paint mixed by silver paste, and acrylic resin.

4. The substrate defined in claim 2, being comprised of metal material.

5. The substrate defined in claim 2, further comprising:
a reinforced framing strip extended and folded by said first surface at a periphery thereof.

6. The substrate defined in claim 2, further comprising:
a through-hole arranged at a proper location for hanging intended articles.

7. The substrate defined in claim 2, further comprising:
a marking letter or decorative pattern punched at a proper location thereof.

8. The substrate defined in claim 2, being embedded onto a wall surface of classrooms and offices as well as predefined location of partition wall.
